(19) United States
(12) Patent Application Publication
(10) Pub. No.: US 2026/0155735 A1
(43) Pub. Date: Jun. 4, 2026

(54) METHOD FOR OPERATING A GATE DRIVER, A GATE DRIVER, A DRIVE ASSEMBLY, A POWERTRAIN AND A MOTOR VEHICLE

(71) Applicant: GKN Automotive Limited, Birmingham (GB)

(72) Inventors: Tobias Weling, Lohmar (DE); Norbert Hittmann, Lohmar (DE)

(21) Appl. No.: 19/403,657

(22) Filed: Nov. 28, 2025

(30) Foreign Application Priority Data
Nov. 29, 2024 (DE) 102024135409.7

(51) Int. Cl. H02M 1/08; B60L 15/00; B60L 50/51; H02M 7/5395

(52) U.S. Cl. CPC H02M 1/08; H02M 7/5395; B60L 15/007; B60L 50/51

(57) ABSTRACT

A method for operating a driver for an arrangement of electrical components, wherein an electrical first component is controlled by a first PWM signal with a first frequency; wherein a second PWM signal with a second frequency, which is higher than the first frequency, is generated in the driver; wherein an electrical second component is controlled with the second PWM signal and an output capacitor is thereby charged; wherein on a rising edge of a first pulse of the first PWM signal, a first current signal with a first voltage from the output capacitor is applied to the first component.

### CROSS REFERENCE TO RELATED APPLICATIONS

This application claims the priority to German Patent Application No. DE102024135409.7 filed on Nov. 29, 2024, and the content of this priority application is incorporated herein by reference in its entirety.

### TECHNICAL FIELD

The disclosure relates to a method for operating a (gate) driver, a (gate) driver, a drive assembly, a powertrain and a motor vehicle.

### BACKGROUND

A gate driver (a so-called gate driver, isolating converter or flyback controller) is an isolated power supply which is usually used in converters (e.g. rectifiers, i.e. inverters, or also in DC-DC converters), which are intended for use in traction drives, for example.

The converter converts the DC current taken from a traction battery, for example, into an AC current or a higher voltage DC current and uses it to drive a traction drive. Within the converter, the energy or power required to drive the traction drive is converted and supplied via power electronics.

The regulation of the energy or the power is usually carried out via a microcontroller, wherein the microcontroller provides a (first) PWM signal (pulse-width modulated signal) on a low-voltage side (primary side). This PWM signal of the low-voltage side is converted by the gate driver into a gate signal on a high-voltage side (secondary side), wherein the gate of a power switch is controlled by the gate signal. As a result of the gate signal, the power switch is controlled such that the current required to drive the traction drive is supplied via the power switch.

A gate driver directs the (first) PWM signal, electrically isolated from the microcontroller of the converter, to the gate of an (e.g., IGBT/SiC/GaN) power switch (IGBT: Insulated Gate Bipolar Transistor; SiC: silicon carbide; GaN: gallium nitride). Gate drivers thus protect persons and equipment from hazards caused by electrical voltage. For this purpose, the gate driver generates a positive and a negative output voltage for the power switch on the high-voltage side, so that depending on the first PWM signal of the microcontroller on the low-voltage side, the gate is opened (the gate driver provides a positive (first) voltage for the gate) or closed (the gate driver provides a negative (second) voltage to the gate).

This positive (first) voltage and negative (second) voltage are generated by a separate control unit of the gate driver. The energy required to switch the gate is stored in so-called (buffer) output capacitors of this control unit. To charge these output capacitors, the control unit is activated on a low-voltage side with its own second PWM signal, this signal being transferred to a galvanically isolated high-voltage side and used to charge the output capacitors located there. This second PWM signal has a much higher (constant) frequency than the first PWM signal. The second PWM signal can have a constant pulse duration and accordingly a constant pause duration, or else a load-dependent variable pulse duration and pause duration respectively.

A low-voltage side and a high-voltage side of the gate driver are galvanically isolated from each other. Gate drivers allow high currents to be provided for switching power switches, which means that SiC and IGBT power switches designed for several 100 kW of drive power can also be switched without the need for the additional external buffer.

A gate driver is generally provided as a separate electronic module. Modern or yet to be provided semiconductor generations of IGBT/SiC gate drivers include the circuits of the gate driver within the IC chip (IC internal controller), which saves the need for a separate chip and associated housing.

The secondary-side (high-voltage side) control of the gate driver is used to generate an exact output voltage (first voltage or second voltage). When the power switch is switched on, large currents (several tens of amperes) are drawn from the gate driver or its high-voltage side. For this reason, large capacitance values in the range of several tens of microfarads are required on the high-voltage side to provide stabilization and to minimize voltage drops. These capacitances are also referred to as (buffer) output capacitors.

A problem with existing gate drivers is that when a power module or power switch is switched on due to the gate current, a voltage drop occurs at the output capacitors. Conventional gate drivers therefore require large output capacitors. If the capacitors are designed too small, the voltage for switching the gate may sometimes not be able to be provided. Accordingly, the requested traction drive power cannot be provided. The considerable size and weight of these capacitors, which is required for this purpose, can increase their costs. In addition, the performance of the gate driver can be affected by the large output capacitance. It can affect the transient response and result in slower voltage regulation.

A similar problem exists with the power output of DC-DC converters. Here, the voltage of a battery is regulated by the DC-DC converter to a voltage required for the operation of an electric motor. In addition, the electrical power is made available to the motor as required. To activate the motor, a bridge is usually provided, which is activated via a first PWM signal from a control unit. An (output) capacitor (or a plurality of capacitors) is usually provided between the converter and the bridge, from which additional energy can be supplied. If the capacitors are designed too small, the power required to operate the motor may sometimes not be able to be provided immediately.

The object of at least some implementations of the present disclosure is to at least partially solve the problems listed in relation to the prior art. In particular, a method for operating a gate driver is to be proposed, which, on the one hand, ensures switching of the gate and, on the other hand, allows the costs of the gate driver to be reduced. In particular, a method for operating a driver is additionally proposed, which can reduce or prevent a possible delay in providing power to an electric motor.

### SUMMARY

The features listed individually in the claims can be combined with each other in any technologically meaningful way and can be supplemented by explanatory statements from the description and/or details from the drawings, wherein further design variants of the disclosure are demonstrated.

A method for operating a driver for an arrangement of electrical components is proposed, wherein an electrical first component is controlled by a first PWM signal with a (constant or varying) first frequency. The driver generates a second PWM signal with a (constant or varying) second frequency that is (always) higher than the first frequency. The second PWM signal is used to control an electrical second component, thereby charging an output capacitor. On a rising edge of a first pulse of the first PWM signal, a first current signal with a first voltage from the output capacitor is applied to the first component. The method comprises the following steps:
a) generating the second PWM signal with (a plurality of consecutive) second pulses, the second pulses having a (constant) first pulse duration;
b) detecting that the rising edge of the first PWM signal begins; (and immediately thereafter)
c) varying the second PWM signal by extending the first pulse duration to a (constant) second pulse duration.

The driver is particularly suitable for activating an arrangement of electrical components (e.g. a DC-DC converter and a bridge) and comprises a control unit. The driver can receive or generate a first PWM signal with a first frequency and generates a second PWM signal with a second frequency which is higher than the first frequency. As described above, the first PWM signal is used to activate the bridge (as the electrical first component). The second PWM signal is used to activate the converter (as the electrical second component). The converter can be used to charge a capacitor located between the converter and the bridge. The method can be used to carry out this charging in a targeted manner depending on the first PWM signal. The second PWM signal is varied depending on the first PWM signal.

The driver is in particular part of a drive assembly which comprises at least one electric motor and a converter as well as a bridge. The DC-DC converter is used to convert and transfer energy from a battery to the electric motor. The drive assembly comprises a control device, wherein the control device regulates a current transferred from the converter to the motor. The drive assembly comprises a driver that is suitable for activating the drive assembly or the converter and the bridge.

In particular or alternatively, the driver is a gate driver (an isolating converter or flyback controller), which is suitable for activating a gate (as an electrical first component) of a power switch. The gate driver controls the gate of the power switch. The gate is controlled by the first PWM signal with the first frequency. The second PWM signal is generated in the gate driver with the second frequency, wherein the second PWM signal is applied to a circuit (as the electrical second component) of the gate driver, which circuit comprises at least one first output capacitor and a second output capacitor, for charging the output capacitors.

A method for operating a gate driver is (additionally) proposed. The gate driver controls a gate of a (e.g. IGBT/SiC/GaN) power switch. The gate is controlled by a first PWM signal with a (constant or varying) first frequency. The gate driver generates a second PWM signal with a (constant or varying) second frequency that is (always) higher than the first frequency. The second PWM signal is applied to a circuit of the gate driver, which has at least one first output capacitor and a second output capacitor, for charging the output capacitors.

On a rising edge of a first pulse of the first PWM signal, a first current signal with a first voltage from the first output capacitor is applied to the gate, and for a falling edge of the first pulse, a second current signal with a second voltage from the second output capacitor is applied to the gate.

Starting from a first state in which there is a pause between two first pulses, the method comprises at least the following steps:
a) generating the second PWM signal with (a plurality of consecutive) second pulses, the second pulses having a (constant) first pulse duration;
b) detecting that the rising edge of the first PWM signal begins; (and immediately thereafter)
c) varying the second PWM signal by extending the first pulse duration to a (constant) second pulse duration.

Alternatively or additionally, starting from a second state in which the first pulse is (already) present, the method comprises at least the following steps:
x) generating the second PWM signal with (a plurality of consecutive) second pulses, the second pulses having a first pulse duration;
y) detecting that the falling edge of the first PWM signal begins;
c) varying the seconnd PWM signal by extending the first pulse duration to a (constant) second pulse duration.

In particular, a solution for existing gate drivers is to be proposed. In this respect, reference is made to the mode of operation of a gate driver described above. In particular, a method is proposed by which a voltage (or an absolute value of the relevant first or second voltage) at the gate is to be increased on the basis of the instant that the power switch is switched on. In this case, as part of the method for operating the gate driver of the power switch (in particular a bipolar transistor with isolated control electrode—IGBT), a second PWM signal is generated and provided which can be varied depending on the first PWM signal. In particular, the duty cycle of the pulse width modulation (PWM) of the second PWM signal is increased.

In particular, the method can ensure that when large currents flow when the power switch is switched on (or when the bridge is operated), a higher stabilization and a lower voltage drop at the output capacitor(s) occur. The mechanism by which this is achieved involves in particular increasing the duty cycle of the second PWM signal as an (immediate) reaction to a rising edge of the first PWM signal, whereby a larger charge is generated at the output capacitor(s). This boost event (i.e. the increase in the duty cycle) can be used to reduce or even prevent a voltage drop at the output capacitor in question. In addition, even a capacitance of the relevant output capacitor can be reduced, so that component costs of the (gate) driver and space occupied by the (gate) driver can be reduced. The proposed method can improve the efficiency and reliability of the power supply in systems which use, for example, these power switches.

In particular, the gate driver comprises a low-voltage side (primary side) and a high-voltage side (secondary side). In particular, a (first) PWM signal is provided by a microcontroller on the primary side of the gate driver. This first PWM signal is received at a first circuit of the gate driver.

The first PWM signal is used in particular to provide the required energy from a battery for a (traction) motor. This first PWM signal of the low-voltage side is converted by the gate driver into a gate signal on a high-voltage side (secondary side), wherein the gate of the power switch is controlled by the gate signal. The power switch is located on the secondary side. As a result of the gate signal, the power switch is controlled such that the current required to drive the traction drive is supplied via the power switch.

The gate driver generates a positive and a negative output voltage for the power switch on its high-voltage side (secondary side), so that, depending on the first PWM signal of the microcontroller on the low-voltage side, the gate is closed (the gate driver provides a positive (first) voltage for the gate) or opened (the gate driver provides a negative (second) voltage for the gate).

In particular, the gate driver comprises a second circuit that generates the second PWM signal on the primary side. On the secondary side, the second PWM signal is used by the second circuit to charge the output capacitors. The output capacitors are part of a circuit forming the secondary side of the second circuit.

The first output capacitor serves in particular to provide a positive (first) voltage, which can be used to apply a first current signal to the gate of the power switch for switching, i.e. closing, the power switch.

The second output capacitor serves in particular to provide a negative (second) voltage, which can be used to apply a second current signal to the gate of the power switch for switching, i.e. opening, the power switch.

Using the second circuit, the second PWM signal is thus generated on the primary side and used on the secondary side to charge the output capacitors. In addition, the gate is switched by the second circuit by discharging the respective output capacitor and by the current signals formed thereby.

During discharging of the output capacitor, a voltage drop can occur at the output capacitor, especially at high currents. The up and down nature of the voltage at the output capacitor is also referred to as voltage fluctuation or voltage ripple. This voltage drop can now be at least partially compensated, balanced or overcompensated using the method.

The method distinguishes in particular two states:
1) In the first state, there is a pause between two first pulses. The pause ends with a rising edge.
2) In the second state, the first pulse is already present. The first pulse ends with a falling edge.
   The duration of each first pulse or the pause between the first two pulses may vary (in particular depending on the power requirement).

Starting from the first state, the method (for the driver or gate driver) comprises in particular the following steps:
a) generating the second PWM signal with (a plurality of consecutive) second pulses (depending on the first PWM signal), wherein the second pulses have a (constant) first pulse duration (and a constant second frequency); (and then)
b) detecting that the rising edge of the first PWM signal begins; (and immediately thereafter)
c) varying the second PWM signal by extending the first pulse duration toward a (constant) second pulse duration (and maintaining the constant second frequency).

Starting from the second state, the method (for the gate driver) comprises in particular the following steps:
x) generating the second PWM signal with (a plurality of consecutive) second pulses (depending on the first PWM signal), wherein the second pulses have a (constant) first pulse duration (and a constant second frequency); (and then)
y) detecting that the falling edge of the first PWM signal begins; (and immediately thereafter)
z) varying the second PWM signal by extending the first pulse duration toward a (constant) second pulse duration (and maintaining the constant second frequency).

By extending the pulse duration, the discharge of the output capacitor (which in particular occurs simultaneously with steps b), c) or y), z) respectively) can be at least partially compensated, fully compensated or even overcompensated.

In particular, the driver is operated with at least one (or more than one or all) of the following parameters (in particular specifically when used in conjunction with a DC-DC converter):
first frequency (of the first PWM signal): at least 1 kHz; not more than 1 MHz, in particular not more than 15 kHz;
second frequency (of the second PWM signal): at least 10 kHz, in particular at least 100 kHz; not more than 100 MHz, in particular not more than 50 MHz, preferably not more than 10 MHz;
second frequency>10×first frequency (i.e. second frequency always greater than first frequency, in particular at least 20 times greater);
output capacitor (total): at least 1 μF, in particular at least 100 μF; not more than 10 mF, in particular not more than 1 mF;
input voltage of a converter used as an electrical first component: at least 5 V, in particular at least 10 V; not more than 500 Volt, in particular not more than 50 Volt, preferably not more than 20 Volt;
output voltage of the converter (first component): at least 10 V, preferably at least 40 Volt; not more than 1,000 V, in particular not more than 100 V;
input voltage of the second PWM signal (i.e. on the primary side): at least 5 V, in particular at least 10 V; not more than 500 V, in particular not more than 100 V;
pulse duration: at least 1%; not more than 100%; wherein second pulse duration>1.5×first pulse duration, in particular at least 2 times greater.

In particular, the gate driver is operated with at least one (or more than one or all) of the following parameters (specific to the gate driver):
first frequency (of the first PWM signal): at least 1 kHz; not more than 20 kHz;
second frequency (of the second PWM signal): at least 10 kHz, in particular at least 100 kHz; not more than 100 MHz, in particular not more than 50 MHz, preferably not more than 10 MHz;
second frequency>10×first frequency (i.e. second frequency always greater than first frequency, in particular at least 20 times greater);
(first and second) output capacitor (in each case): at least 1 μF, in particular at least 100 μF; not more than 10 mF, in particular not more than 1 mF;
first (nominal) voltage (when first pulse duration applied): at least 10 V, in particular at least 15 V; not more than 20 V;
second (nominal) voltage (when first pulse duration applied): at least −20 V, not more than 0 V; not more than −5 V;
input voltage of the second PWM signal (i.e. on the primary side): at least 5 V, in particular at least 10 V; not more than 500 V, in particular not more than 100 V;
pulse duration: at least 1%; not more than 100%; wherein second pulse duration>1.5×first pulse duration, in particular at least 2 times greater.

In particular (in the method for operating the driver and the gate driver), the second pulse duration is maintained for at least two (optionally three, four or more) second pulses and then (i.e. after step c) or z)) the second PWM signal is (again) varied or shortened by shortening the second pulse duration.

In particular (in the method for operating the driver and the gate driver), the second pulse duration is (again) shortened to the first pulse duration.

In particular (in the method for operating the driver and the gate driver), the pulse duration (in step a) or x)) is either equal to the constant absolute value of the first pulse duration or (in step c) or z)) the constant absolute value of the second pulse duration.

In particular (in the method for operating the driver and the gate driver), the second pulse duration is maintained for at least (or at most) 20 % of the duration of the first pulse or (in the method for operating the gate driver) for at least (or not more than) 20 % of a duration of the pause between two first pulses (in particular for at least or at most 40 % of the duration, preferably for at least or at most 60 % of the duration, particularly preferably for at least or at most 80 % of the duration).

In particular, (in the method for operating the driver and the gate driver) at least the steps a) to c) or (in the method for operating the gate driver) steps x) to z) are carried out for each first pulse.

In particular, after each first pulse or after each execution of the method steps a) to c) (in the method for operating the driver and the gate driver) or steps x) to z) (in the method for operating the gate driver), second PWM signals with first pulse duration are again present before second PWM signals with second pulse duration are generated again.

In particular, steps a) to c) (in the method for operating the driver and the gate driver) and/or steps x) to z) (in the method for operating the gate driver) are repeated with each first pulse, with steps c) and z) being carried out only in a time-limited way.

In particular, (in the method for operating the driver and the gate driver) by extending the pulse duration of the second PWM signal, the respective (first/second) (nominal) voltage is varied or increased in size by at least (or at most) 10%, preferably by at least (or at most) 15%, of the absolute value of its voltage.

A driver is further proposed, which is suitable for activating an arrangement of electrical components and comprises a control unit. The driver receives or generates a first PWM signal with a first frequency and generates a second PWM signal with a second frequency which is higher than the first frequency. The control unit is suitable for carrying out the described method and the second PWM signal can be varied depending on the first PWM signal.

The driver is suitable in particular for activating an arrangement of electrical components (e.g. a DC-DC converter and a bridge). As described above, the first PWM signal is used to activate the bridge (as the electrical first component). The second PWM signal is used to activate the converter (as the electrical second component). The converter can be used to charge a capacitor located between the converter and the bridge. The method can be used to carry out this charging in a targeted manner depending on the first PWM signal. The second PWM signal is varied depending on the first PWM signal.

The driver is in particular part of a drive assembly which comprises at least one electric motor and a converter, as well as a bridge (as electrical components). The DC-DC converter is used to convert and transfer energy from a battery to the electric motor. The drive assembly comprises a control device, wherein the control device regulates a current transferred from the converter to the motor. The drive assembly comprises a driver that is suitable for activating the arrangement of electrical components of the drive assembly (e.g. the converter and the bridge).

In particular or alternatively, the driver is a gate driver (an isolating converter or flyback controller), which is suitable for activating a gate (as an electrical first component) of a power switch. The gate driver controls the gate of the power switch. The gate is controlled by the first PWM signal with the first frequency. The second PWM signal is generated in the gate driver with the second frequency, wherein the second PWM signal is applied to a circuit (as the electrical second component) of the gate driver, which circuit comprises at least one first output capacitor and a second output capacitor, for charging the output capacitors.

Thus, a gate driver is further proposed, which is designed for activating a gate (as the electrical first component) of a power switch suitable. The gate driver has a primary side and a secondary side that is galvanically isolated from the primary side, and a control unit. The gate driver comprises at least one first circuit for receiving a first PWM signal with a first frequency on the primary side and a second circuit for generating a second PWM signal with a second frequency, which is higher than the first frequency, on the primary side. The second circuit comprises at least one first output capacitor and a second output capacitor on the secondary side. The output capacitors can be charged via the second PWM signal and the gate arranged on the secondary side can be switched by at least partially discharging the respective output capacitor. The control unit is suitable for carrying out the method described (in particular with regard to the gate driver) or comprises means for carrying out the steps of the method and/or comprises means which are suitably equipped, configured or programmed, or which carry out the method. The second PWM signal can be varied depending on the first PWM signal (in particular with regard to the first or second pulse duration, in particular by the control unit).

A drive assembly is further proposed, at least comprising an electric motor and a converter for converting and transferring energy from a battery to the electric motor, as well as a control device, wherein the control device regulates a current transmitted from the converter to the motor and the drive assembly comprises the driver described, which is suitable for activating the arrangement of electrical components of the drive assembly (i.e., for example, the converter and the bridge) or comprises means for activating the drive assembly and/or comprises means which are suitably equipped, configured or programmed for actuating the drive assembly or which activate the drive assembly.

In particular, the converter is a DC-DC converter. In particular, an input voltage of the converter in this case is at least 5 Volt and not more than 500 Volt, in particular at least 10 Volt and not more than 50 Volt or not more than 20 Volt. In particular, an output voltage of the converter is at least 10 Volt and not more than 1000 Volt, preferably at least 40 Volt and not more than 100 Volt.

In particular, the converter is a DC-DC converter and a so-called or known B6/H-bridge is arranged between the motor and the converter. In particular, the converter is connected to the battery via a filter. In particular, a first frequency of the first PWM signal with which the bridge is operated is at least 10 kHz and not more than 1 MHz, preferably at least 5 kHz and not more than 100 kHz. In particular, a second frequency of the second PWM signal applied to the converter is at least 10 kHz and not more than 100 MHz, in particular at least 1 MHz and not more than 10 MHz.

In particular, the current regulated by the control device is transferable between the converter and the motor via at least one power switch and the drive assembly comprises the described gate driver, which is suitable for activating a gate of the at least one power switch.

In particular, the converter is a DC-AC converter (a so-called inverter).

A drive train for a motor vehicle is further proposed, at least comprising a battery (also referred to as a secondary battery) for storing electrical energy, and the drive assembly described, wherein the motor (also referred to as a traction drive) can be connected to a drive shaft for transmitting torque and the converter is suitable for transferring the energy from the battery to the electric motor and from the electric motor to the battery.

A motor vehicle is further proposed, at least comprising the described drive train and a drive shaft connected to the engine for transmitting torque. The motor vehicle may also comprise a plurality of drive shafts (driven by the one motor or by other motors).

In particular, the control unit and/or the control device is provided as a data processing system, which comprises means that are suitably equipped, configured or programmed for carrying out the method or for activating the gate, or which carry out the method and/or activate the gate.

The means comprise, for example, a processor and a memory, in which commands to be executed by the processor are stored, as well as data or signal lines or transmission devices, which enable the transmission of commands, measurements, data or similar between the specified elements.

The “means” may comprise, in particular, one or more of the following components: controller(s), microcontroller, data storage, data connection, display devices (such as a display), counter or timing element (timer), at least one additional sensor, an energy source, etc.

A computer program is further proposed, comprising commands which, during execution of the computer program by a computer, cause the latter to carry out the described method or the steps of the described method.

A computer-readable storage medium is further proposed, comprising commands which, during execution by a computer, cause the latter to carry out the described method or the steps of the described method.

The embodiments of the method are transferable in particular to the drive assembly, the drive train, the motor vehicle, the control device or the data processing system and/or the computer-implemented method (i.e. the computer program and the computer-readable storage medium), and vice versa.

In particular, two different applications of the described method are thus proposed. Firstly, for a driver, which is used, for example, for regulating a drive assembly comprising a DC-DC converter (second component), a bridge (first component) and a motor. A capacitance provided between the converter and the bridge is (re)charged as quickly as possible, so that the power required to operate the motor is available at all times.

Secondly, for a gate driver, which is suitable for activating a gate (as a first component) of a power switch. The gate driver controls the gate of the power switch. The second PWM signal is generated in the gate driver, wherein the second PWM signal is applied to a circuit (as the electrical second component) of the gate driver, which circuit comprises at least one first output capacitor and a second output capacitor, for charging the output capacitors.

The use of indefinite articles (“a”, “an”), in particular in the claims and in the description which reflects them, is to be understood as such and not as a numeral. Accordingly, terms or components introduced in this way shall be understood to mean that they are present at least once and, in particular, may also be present more than once.

As a precaution, it should be noted that the numerals used here (“first”, “second”, . . . ) primarily serve (only) to distinguish between multiple objects, variables or processes of the same type, i.e. in particular do not stipulate any dependency and/or sequence of these objects, variables or processes with respect to each other. Where a dependency and/or sequence is required, this is explicitly stated here or will become obvious to the person skilled in the art when studying the specific embodiment described. If a component can occur more than once (“at least one”), the description given for one of these components may apply equally to all or some of the plurality of these components, but this is not mandatory.

### BRIEF DESCRIPTION OF THE DRAWINGS

The disclosure as well as the technical background will be explained in more detail below on the basis of the attached drawings. It should be noted that the disclosure is not intended to be limited by the exemplary embodiments cited. In particular, it should be noted that the figures and in particular the proportions shown in the figures are only schematic. In the drawing:

FIG. 1: shows a motor vehicle with a drive train;

FIG. 2: shows a gate driver and a power switch;

FIG. 3: shows a first graph;

FIG. 4: shows a second graph;

FIG. 5: shows an illustration of steps a), b), c) or x), y), z);

FIG. 6: shows a third graph with a comparison of steps a) and c) or x) and z);

FIG. 7: shows a fourth graph illustrating the effect of the method; and

FIG. 8: shows an arrangement.

### DETAILED DESCRIPTION

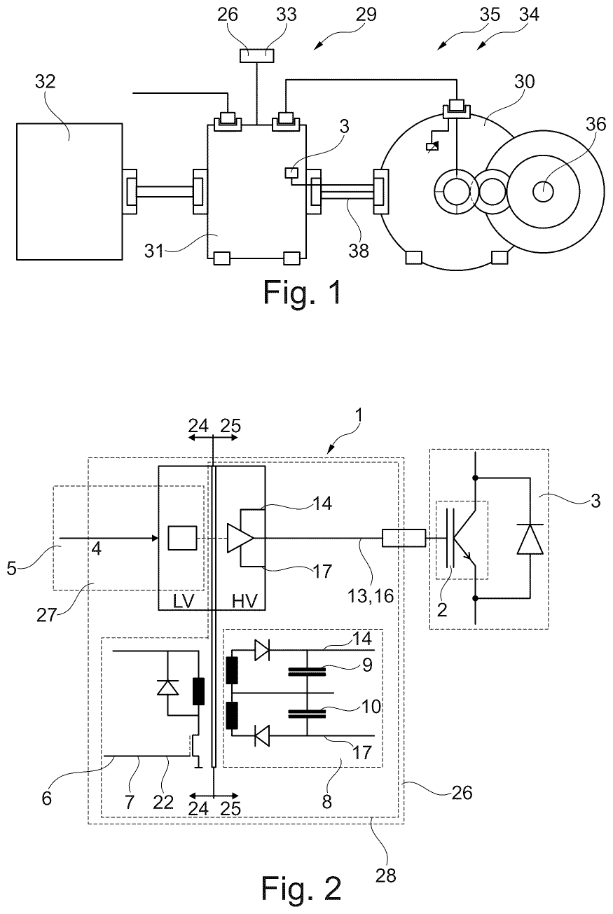

FIG. 1 shows a motor vehicle 35 with a drive train 34 and a drive shaft 36 connected to the motor 30 for transmitting torque. Furthermore, the drive train 34 comprises a converter 31 for transferring the energy from the battery 32 to the electric motor 30 and from the electric motor 30 to the battery 32. In addition, the drive train 34 or the motor vehicle 35 comprises a control device 33. Motor 30 and converter 31 together with the control device 33 form a drive assembly 29. The control unit 33 regulates a current 38 transferred from the converter 31 via at least one power switch 3 to the motor 30.

FIG. 2 shows a gate driver 1 and a power switch 3. Reference is made to the explanations given for FIG. 1.

The drive assembly 29 indicated in FIG. 1 comprises a gate driver 1, which is suitable for activating a gate 2 of the power switch 3.

The gate driver 1 is suitable for activating a gate 2 of a power switch 3. The gate driver 1 comprises, in a known manner, a primary side 24 and a secondary side 25 galvanically isolated from the primary side 24, and a control unit 26. The gate driver 1 comprises a first circuit 27 for receiving a first PWM signal 4, which has a first frequency 5, on the primary side 24. Further, the gate driver 1 comprises a second circuit 28 for generating a second PWM signal 6, which has a second frequency 7 which is higher than the first frequency 5, on the primary side 24. The second circuit 28 has a first output capacitor 9 and a second output capacitor 10 on the secondary side 25. The output capacitors 9, 10 can be charged via the second PWM signal 6 and the gate 2 arranged on the secondary side 25 can be switched by at least partially discharging the respective output capacitor 9, 10. The control unit 26 is suitable for carrying out the method described in the following.

In contrast to known gate drivers 1, the second PWM signal 6 can be varied in a particular manner (in particular with regard to the first or second pulse duration 20, 21, in particular by the control unit 26) depending on the first PWM signal 4.

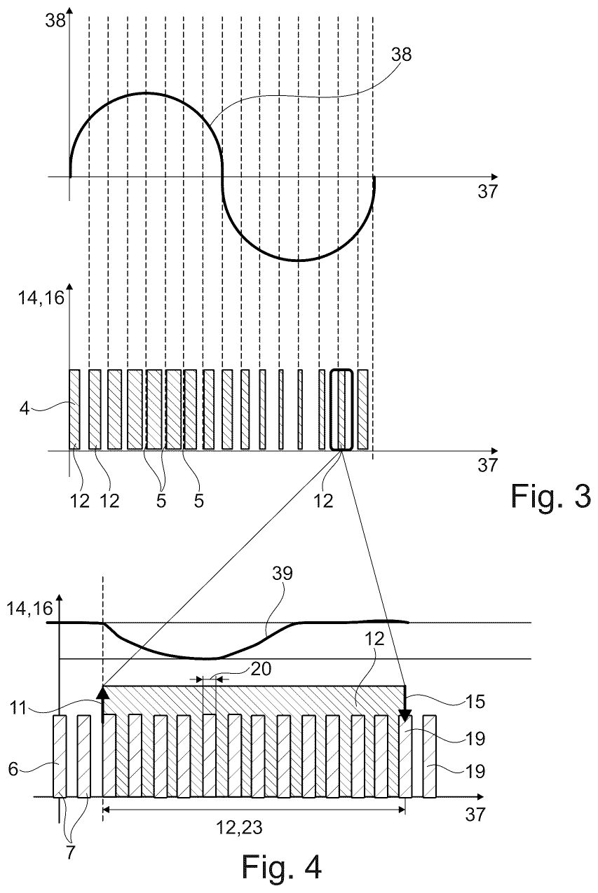

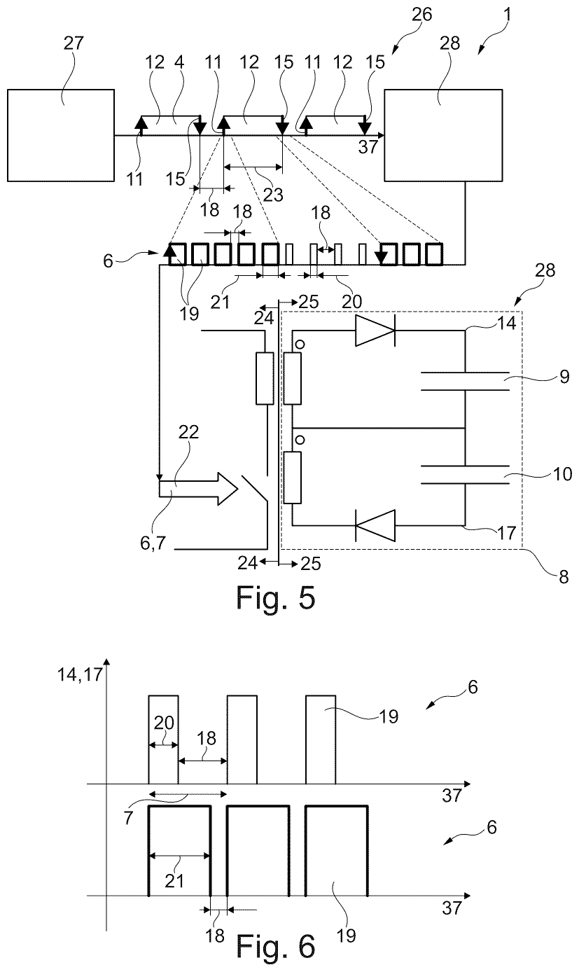

FIG. 3 shows a first graph. FIG. 4 shows a second graph. FIG. 5 shows an illustration of steps a), b), c) or x), y), z). FIG. 6 shows a third graph with a comparison of steps a) and c) or x) and z). FIG. 6 shows a fourth graph illustrating the effect of the method. FIGS. 3 to 7 are described together in the following. Reference is made to the explanations given for FIGS. 1 and 2.

In the first graph according to FIG. 3, the current 38 of one phase of the motor 30 is shown in the upper part on the vertical axis and the time 37 is shown on the horizontal axis. In the lower part of FIG. 3, the vertical axis represents the first PWM signal 4 generating the current 38 and the horizontal axis represents the time 37.

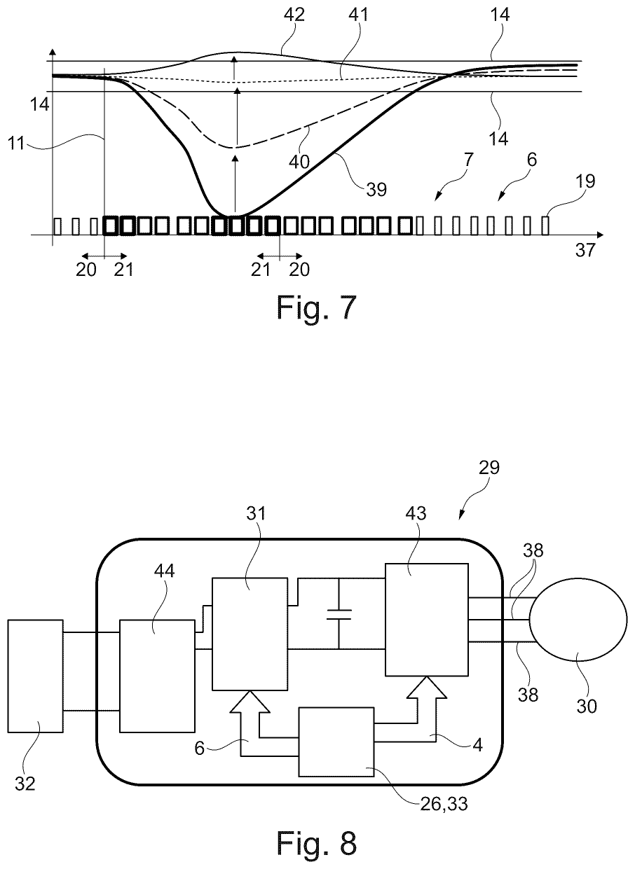

In the second graph according to FIG. 4, in the third graph according to FIG. 6 and in the fourth graph according to FIG. 7, the voltages 14, 17 are plotted on the vertical axis and the time 37 is plotted on the horizontal axis.

A gate driver 1 is an isolated power supply which is usually used in converters 31 (e.g. rectifiers, i.e. inverters, or also in DC-DC converters), which are intended for use in traction drives, for example.

The converter 31 converts the DC current taken from a traction battery 32, for example, into an AC current or a higher voltage DC current and uses it to drive a traction drive or motor 30. Within the converter 31, the energy or power required to drive the traction drive 30 is converted and supplied via power electronics.

The regulation of the energy or the power is usually carried out via a microcontroller (here designated by control unit 26), wherein the microcontroller provides a first PWM signal 4 on a low-voltage side (primary side 24). This first PWM signal 4 of the primary side 24 is converted by the gate driver 1 into a gate signal (current signal 13, 16) on a high-voltage side (secondary side 25), wherein the gate 2 of a power switch 3 is controlled by the current signal 13, 16. As a result of the current signal 13, 16, the power switch 3 is controlled such that the current 38 required to drive the motor 30 is supplied via the power switch 3.

A gate driver 1 directs the first PWM signal 4, electrically isolated from the control unit 26 of the converter 31, to the gate 2 of a power switch 3. The gate driver 1 generates a positive and a negative output voltage for the power switch 3 on the secondary side 25, so that, depending on the first PWM signal 4 of the control unit 26 on the primary side 24, the gate 2 is closed (the gate driver 1 provides a positive first voltage 14 for the gate 2) or opened (the gate driver 1 provides a negative second voltage 17 for the gate 2).

This positive first voltage 14 and negative second voltage 17 are generated via a separate control unit (second circuit 28) of the gate driver 1. The energy required to switch the gate 2 is stored in so-called (buffer) output capacitors 9, 10 of this second circuit 28. To charge these output capacitors 9, 10, the control unit 26 is activated on a low-voltage side (primary side 24) with its own second PWM signal 6, this signal 6 being transferred to a galvanically isolated high-voltage side (secondary side 25) and used to charge the output capacitors 9, 10 arranged there. This second PWM signal 6 has a significantly higher (constant) second frequency 7 than the first PWM signal 4 and also has a constant first pulse duration 20 and accordingly a constant duration 23 of the pause 18 (see FIG. 4). The second PWM signal 6 is provided on the primary side 24 with an input voltage 22.

A low-voltage (primary side 24) and a high-voltage side (secondary side 25) of the gate driver 1 are galvanically isolated from each other. Gate drivers 1 allow high currents to be provided for switching power switches 3, which means that SiC and IGBT power switches 3 designed for several 100 kW of drive power can also be switched without the need for the additional external buffers.

The secondary (high-voltage side) control (second circuit 28) of the gate driver 1 is used to generate an accurate output voltage (first voltage 14 or second voltage 17). When the power switch 3 is switched on, large currents 38 (several tens of amperes) are drawn from the gate driver 1 or its secondary side 25. For this reason, large capacitance values in the range of several tens of microfarads are required on the secondary side 25 to provide stabilization and to minimize voltage drops. These are also referred to as (buffer) output capacitors 9, 10. Such a drop in voltage (the first voltage 14) is shown in FIG. 4.

A problem with existing gate drivers 1 is that when a power module or power switch 3 is switched on due to the gate current 38, a voltage drop occurs at the output capacitors 9, 10. Conventional gate drivers 1 therefore require large output capacitors 9, 10. If the capacitors 9, 10 are designed too small, the voltage 14, 17 for switching the gate 3 may sometimes not be able to be provided. Accordingly, the requested power for the traction drive or motor 30 cannot be provided. The considerable size and weight of these capacitors 9, 10, which is required for this purpose, can increase their costs. In addition, the performance of the gate driver 1 can be adversely affected by the large output capacitance. It can affect the transient response and result in slower voltage regulation.

In the method described here, a gate 2 of a power switch 3 is controlled via the gate driver 1. The gate 2 is controlled by a first PWM signal 4 with a constant first frequency 5 (see FIGS. 3 and 4 as well as FIG. 5, upper part). In the gate driver 1, a second PWM signal 6 is generated with a constant second frequency 7, which is always higher than the first frequency 5 (see FIG. 4 and FIG. 5). The second PWM signal 6 is applied to a circuit 8 of the gate driver 1, which has a first output capacitor 9 and a second output capacitor 10, for charging the output capacitors 9, 10.

On a rising edge 11 of a first pulse 12 of the first PWM signal 4, a first current signal 13 with a first voltage 14 from the first output capacitor 9 is applied to the gate 2, and for a falling edge 15 of the first pulse 12 a second current signal 16 with a second voltage 17 from the second output capacitor 10 is applied to the gate (see FIGS. 2, 3 and 4).

The described method is intended as a proposed solution for existing gate drivers 1. A method is proposed by which a voltage 14, 17 (or an absolute value of the relevant first or second voltage) at the gate 2 is to be increased on the basis of the instant that the power switch 3 is switched on. In this method, as part of the method for operating the gate driver 1 of the power switch 3, a second PWM signal 6 is generated and provided, which can be varied depending on the first PWM signal 4. This involves increasing the duty cycle of the pulse width modulation (PWM) of the second PWM signal 6.

The method can be used to ensure that, when large currents 38 flow when the power switch 3 is switched on, a higher stabilization and a lower voltage drop are present or occur at the output capacitors 9, 10. The mechanism by which this is achieved consists of increasing the duty cycle of the second PWM signal 6 as an (immediate) reaction to a rising edge 11 of the first PWM signal 4 (see FIGS. 5 and 6), whereby a larger charge is generated on the output capacitor(s) 9, 10. This boost event (i.e. the increase in the duty cycle) can be used to reduce or even prevent a voltage drop at the output capacitor 9, 10 in question (see FIG. 7). In addition, even a capacitance of the relevant output capacitor 9, 10 can be reduced, so that component costs of the gate driver 1 and space occupied by the gate driver 1 can be reduced. The proposed method can improve the efficiency and reliability of the power supply in systems which use these power switches 3.

Starting from a first state in which a pause 18 occurs between two first pulses 12, the method comprises at least the steps a) to c). According to step a), the second PWM signal 6 is generated with (a plurality of consecutive) second pulses 19, wherein the second pulses 19 have a constant first pulse duration 20 (see FIG. 5 and FIG. 6, upper part). According to step b), it is detected that the rising edge 11 of the first PWM signal 4 begins (see FIG. 5). Immediately thereafter, according to step c), the second PWM signal 6 is varied by extending the first pulse duration 20 to a constant second pulse duration 21 (see FIGS. 5 and 6).

Alternatively or additionally, starting from a second state in which the first pulse 12 is already present, the method comprises steps x) to z). According to step x), the second PWM signal 6 is generated with a plurality of consecutive second pulses 19, the second pulses 19 having a first pulse duration 20. According to step y), it is detected that the falling edge 15 of the first PWM signal 4 begins. According to step z), immediately after step y), the second PWM signal 6 is varied by extending the first pulse duration 20 to a second pulse duration 21.

The gate driver 1 comprises a low-voltage side (primary side 24) and a high-voltage side (secondary side 25). A first PWM signal 4 is provided by a microcontroller on the primary side 24 of the gate driver 1. This first PWM signal 4 is received at a first circuit 27 of the gate driver 1.

The first PWM signal 4 is used to provide the required energy from a battery 32 for a (traction) motor 30. This first PWM signal 4 of the low-voltage side is converted by the gate driver 1 into a gate signal 13, 16 on a high-voltage side (secondary side 25), wherein the gate 2 of the power switch 3 is controlled by the gate signal 13, 16. The power switch 3 is located on the secondary side 25. As a result of the gate signal 13, 16, the power switch 3 is controlled such that the current 38 required to drive the traction drive/motor 30 is provided via the power switch 3.

The gate driver 1 generates a positive and a negative output voltage 14, 17 for the power switch 3 on its high-voltage side (secondary side 25), so that, depending on the first PWM signal 4 of the microcontroller on the low-voltage side, the gate 2 is closed (gate driver 1 provides a positive first voltage 14 for the gate 2) or opened (the gate driver 1 provides a negative second voltage 17 for the gate 2).

The gate driver 1 comprises a second circuit 28, which generates the second PWM signal 6 on the primary side 24. On the secondary side 25, the second PWM signal 6 is used by the second circuit 28 to charge the output capacitors 9, 10. The output capacitors 9, 10 are part of a circuit 8 forming the secondary side 25 of the second circuit 28.

The first output capacitor 9 serves to provide a positive first voltage 14, which can be used to apply a first current signal 13 to the gate 2 of the power switch 3 for switching, i.e. closing, the power switch 3.

The second output capacitor 10 serves to provide a negative second voltage 17, which can be used to apply a second current signal 16 to the gate 2 of the power switch 3 for switching, i.e. opening, the power switch 3.

Thus, using the second circuit 28, the second PWM signal 6 is generated on the primary side 24 and used on the secondary side 25 to charge the output capacitors 9, 10. In addition, the gate 2 is switched by the second circuit 28 by discharging the respective output capacitor 9, 10 and by the current signals 13, 16 formed thereby.

During discharging of the output capacitor 9, 10, a voltage drop can occur at the output capacitor 9, 10, especially at high currents 38 (see first trace 39 in FIG. 7). The up and down nature of the voltage 14, 17 at the output capacitor 9, 10 is also referred to as voltage fluctuation or voltage ripple. Using the method, this voltage drop can now be at least partially compensated (see second trace 40 in FIG. 7), balanced (see third trace 41 in FIG. 7) or overcompensated (see fourth trace 42 in FIG. 7). The second trace 40 only reaches the minimum of the first nominal voltage 41 again after a certain time 37. The third trace 41 runs between the minimum and the maximum of the first nominal voltage 14. The fourth trace 42 briefly exceeds the maximum of the first nominal voltage 14.

The method distinguishes between two states. In the first state, there is a pause 18 between two first pulses 12. The pause 18 ends with a rising edge 11. In the second state, the first pulse 12 is already present. The first pulse 12 ends with a falling edge 15. The duration 23 of each first pulse 12 or the pause 18 between two first pulses 12 may vary (in particular depending on a power requirement).

By extending the pulse duration 20, 21, the discharge of the output capacitors 9, 10 (which in particular occurs simultaneously with steps b), c) or y), z) respectively) can be at least partially compensated, fully compensated or even overcompensated.

In FIG. 5 it can be seen that the second pulse duration 21 is maintained for five second pulses 19 and then (i.e. after step c) or z)) the second PWM signal 6 is (again) varied or shortened by shortening the second pulse duration 21. The second pulse duration 21 is again shortened to the first pulse duration 20.

The pulse duration 20, 21 (in step a) or x)) is equal to either the constant absolute value of the first pulse duration 20 or (in step c) or z)) the constant absolute value of the second pulse duration 21, i.e. the pulse duration 20, 21 alternates between these two different absolute values.

The second pulse duration 21 can be maintained for a certain duration 23 of the first pulse 12 or for a certain duration 23 of the pause 18 between two first pulses 12.

FIG. 8 shows a drive assembly 29. Reference is made to the explanations given for FIGS. 1 to 7.

The drive assembly 29 comprises an electric motor 30 and a converter 31 for converting and transferring energy from a battery 32 to the electric motor 30, and a control device 33, wherein the control device 33 regulates a current 38 transferred from the converter 31 to the motor 30 via at least one power switch 3. The converter 31 is a DC-DC converter. The converter 31 provides the voltage required to operate the motor 30. A so-called or known B 6/H-bridge 43 (electrical first component 2) is arranged between motor 30 and converter 31. The converter 31 is connected to the battery 32 via a filter 44. The bridge 43 is controlled by the first PWM signal 4 of the control unit 33 and generates the current signals 38 for the different phases of the electric motor 30.

At least one output capacitor 9 is arranged between the converter 31 and the bridge 43. This is used for buffering energy, so that fluctuations in demand of the motor 30 or the bridge 43 can be balanced via the output capacitor. During discharging of the output capacitor 9 (due to the current requirement of the bridge 43 or the motor 30), a voltage drop can occur at the output capacitor 9, especially at high currents 38 (see first trace 39 in FIG. 7). Using the method, the up and down nature of the voltage 14 at the output capacitor 9 or the voltage drop can now be at least partially compensated (see second trace 40 in FIG. 7), balanced (see third trace 41 in FIG. 7) or overcompensated (see fourth trace 42 in FIG. 7). The second trace 40 only reaches the minimum of the first nominal voltage 41 again after a certain time 37. The third trace 41 runs between the minimum and the maximum of the first nominal voltage 14. The fourth trace 42 briefly exceeds the maximum of the first nominal voltage 14. For this purpose, the converter 31 (electrical second component 8) is applied with a second frequency 7 of the second PWM signal 6.

Certain embodiments or components or features of components have been noted herein as being “preferred” and some options as being “preferable” or the like and such indications are to be understood as relating to a preference of the applicant at the time this application was filed. Such embodiments, components or features noted as being “preferred” or “preferable” or the like are optional and are not required for implementation of the innovations disclosed herein unless otherwise indicated as being required, or specifically included within the claims that follow.

1. A method for operating a driver for an arrangement of electrical components, wherein an electrical first component is controlled by a first PWM signal with a first frequency; wherein a second PWM signal with a second frequency, which is higher than the first frequency, is generated in the driver; wherein an electrical second component is controlled with the second PWM signal and an output capacitor is thereby charged; wherein on a rising edge of a first pulse of the first PWM signal, a first current signal with a first voltage from the output capacitor is applied to the first component, wherein the method comprises the following steps:
a) generating the second PWM signal with second pulses, the second pulses having a first pulse duration;
b) detecting that the rising edge of the first PWM signal begins;
c) varying the second PWM signal by extending the first pulse duration to a second pulse duration.

2. The method according to claim 1, wherein the steps a) to c) are carried out when each first pulse occurs.

3. The method according to claim 1, wherein the second pulse duration is maintained for at least two second pulses and then the second PWM signal is varied by shortening the second pulse duration.

4. The method according to claim 3, wherein the second pulse duration is shortened to the first pulse duration.

5. The method according to claim 3, wherein the second pulse duration is maintained over at least 20% of a duration of the first pulse.

6. The method according to claim 1, wherein by extending the pulse duration of the second PWM signal the voltage is varied by at least 10% of its absolute value of the voltage.

7. The method according to claim 1, wherein the driver is a gate driver, the first component is a gate of a power switch and the second component is a circuit of the gate driver; wherein the gate of the power switch is controlled via the gate driver; wherein the gate is controlled by the first PWM signal with the first frequency; wherein the second PWM signal with the second frequency is generated in the gate driver; wherein the second PWM signal is applied to the circuit of the gate driver, which has at least one first output capacitor and a second output capacitor, for charging the output capacitors; wherein on the rising edge of the first pulse of the first PWM signal, the first current signal with the first voltage from the first output capacitor is applied to the gate and for a falling edge of the first pulse a second current signal with a second voltage from the second output capacitor is applied to the gate; wherein the method,
starting from a first state in which a pause occurs between two first pulses, comprises the steps a) to c), or
starting from a second state in which the first pulse is present, comprises the following steps:
x) generating the second PWM signal with second pulses, the second pulses having a first pulse duration;
y) detecting that the falling edge of the first PWM signal begins;
z) varying the second PWM signal by extending the first pulse duration to a second pulse duration.

8. The method according to claim 6, wherein at least the steps a) to c) or the steps x) to z) are carried out when each first pulse occurs.

9. The method according to claim 6, wherein the second pulse duration is maintained over at least 20% of a duration of the first pulse or over at least 20% of a duration of the pause between two first pulses.

10. The method according to claim 6, wherein the gate driver is operated with at least one of the following parameters:
first frequency: at least 1 kHz; not more than 20 kHz;
second frequency: at least 10 kHz; not more than 100 MHz;
second frequency>10×first frequency;
output capacitor: at least 1 μF; not more than 10 mF;
first (nominal) voltage: at least 10 V; not more than 20 V;
second (nominal) voltage: at least −20 V; not more than 0 V;
input voltage of the second PWM signal: at least 5 V; not more than 500 V;
pulse duration: at least 1%; not more than 100%; wherein second pulse duration>1.5×first pulse duration.

11. A driver, which is suitable for activating an arrangement of electrical components and has a control unit; wherein the driver receives or generates a first PWM signal with a first frequency and generates a second PWM signal with a second frequency, which is higher than the first frequency; wherein the control unit is suitable for carrying out the method according to claim 1 and the second PWM signal can be varied depending on the first PWM signal.

12. The driver according to claim 11, wherein the control unit is suitable for carrying out the method according to claim 7, the driver is a gate driver, the first component is a gate of a power switch and the second component is a circuit of the gate driver and the control unit is suitable for activating the gate of the power switch; wherein the gate driver has a primary side and a secondary side electrically isolated from the primary side; wherein the gate driver comprises at least one first circuit for receiving the first PWM signal with a first frequency on the primary side and a second circuit for generating the second PWM signal with a second frequency, which is higher than the first frequency, on the primary side; wherein the second circuit on the secondary side comprises at least one first output capacitor and a second output capacitor and the output capacitors can be charged via the second PWM signal and the gate arranged on the secondary side can be switched by at least partially discharging the respective output capacitor.

13. A drive assembly, at least comprising an electric motor and a converter for converting and transferring energy from a battery to the electric motor, and a control device, wherein the control device regulates a current transferred from the converter to the motor and the drive assembly comprises a driver according to claim 11, which is suitable for activating an arrangement of electrical components of the drive assembly.

14. The drive assembly according to claim 13, wherein the current regulated by the control device is transferable between the converter and the motor via at least one power switch and the drive assembly comprises a gate driver according to claim 12, which is suitable for activating a gate of the at least one power switch.

15. The drive assembly according to claim 14, wherein the converter is a DC-AC converter.
